(19) United States
(12) Patent Application Publication
(10) Pub. No.: US 2010/0297433 A1
(43) Pub. Date: Nov. 25, 2010

(54) BILAYER ANTI-REFLECTIVE FILMS CONTAINING NONOPARTICLES

(75) Inventors: Kostantinos Kourtakis, Media, PA (US); Mark E. Lewittes, Wilmington, DE (US); Rutger D. Puts, Boothwyn, PA (US); Bao-Ling Yu, Glen Mills, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/747,172

(22) PCT Filed: Dec. 18, 2008
(86) PCT No.: PCT/US08/87297

§ 371 Date: Jun. 10, 2010

Related U.S. Application Data
(60) Provisional application No. 61/015,069, filed on Dec. 19, 2007.

(51) Int. Cl. B32B 5/16; B05D 5/06

(52) U.S. Cl. 428/327; 427/162; 977/902

(57) ABSTRACT

Described are nanoparticles-containing stratified compositions, and processes to prepare, for low refractive index compositions of utility as anti-reflective coatings for optical display substrates. The compositions comprise a high index refractive stratum containing nanoparticles and a low refractive index stratum on top of the high index stratum.

### FIELD OF INVENTION

The present invention relates to nanoparticles-containing stratified compositions for low refractive index compositions of utility as anti-reflective coatings for optical display substrates, and to processes to prepare such compositions. The compositions comprise a high index refractive stratum containing nanoparticles and a low refractive index stratum on top of the high index stratum.

### BACKGROUND

Anti-reflective coatings are typically located on the outermost surface of optical displays, such as cathode ray tube displays (CRTs), plasma display panels (PDPs), electroluminescence displays (ELDs), and liquid crystal displays (LCDs), to prevent contrast reduction or reduction of visibility due to reflection of ambient light by making use of optical interference. Refractive index of a material can be reduced by inclusion of fluorine and by decreasing the material density (e.g., voids), but both approaches are accompanied by reductions in film strength (i.e., abrasion resistance). The inclusion of nanoparticles has also been used.

Another method that has been used to overcome these difficulties is to apply two or more antireflection coatings on a substrate, optionally containing nanoparticles, in which the combination of the two layers or stratum together create an anti-reflective layer. However, a two step process is complicated and cost-prohibitive for commercial use.

Thus, it is desirable in the industry to have an anti-reflective film with low reflectivity which can be applied with a low cost, single step coating process.

### SUMMARY

Briefly stated, and in accordance with one aspect of the present invention, there is provided an article comprising:
(i) a substrate; and
(ii) a stratified anti-reflective coating on said substrate, said stratified antireflective coating comprising:
   (iia) a high refractive index lower stratum located on said substrate comprising a low refractive index fluoroelastomer polymeric binder and a plurality of high refractive index nanoparticles which are surface functionalized with an acrylic or vinyl functional group; and
   (iib) a low refractive index upper stratum located on top of said high refractive index lower stratum comprising said low refractive index fluoroelastomer polymeric binder;

wherein the refractive index of the low refractive index upper stratum is lower than the refractive index of the high refractive index lower stratum.

Pursuant to another aspect of the present invention, there is provided a high refractive index stratum that can have a refractive index of 1.41 or greater. Additionally, the stratified anti-reflective coating can be formed on the substrate in a single coating step.

Pursuant to another aspect of the present invention, there is provided a process comprising:
(i) forming a liquid mixture comprising a solvent having dissolved therein:
(i-a) a fluoroelastomer polymer;
(i-b) optionally, a multiolefinic crosslinker;
(i-c) optionally, an oxysilane having at least one polymerizable group;
   and wherein said solvent has suspended therein:
(i-d) a plurality of nanoparticles which are surface functionalized with an acrylic functional group;
(ii) coating said liquid mixture on a substrate to form a liquid mixture coating on said substrate;
(iii) removing solvent from said liquid mixture coating to form an uncured coating on said substrate; and
(iv) curing said uncured coating thereby forming a stratified anti-reflective coating comprising:
   (iv-a) a high refractive index lower stratum located on said substrate comprising said polymeric binder being cured and said plurality nanoparticles; and
   (iv-b) a low refractive index upper stratum located on top of said high refractive index lower stratum comprising polymeric binder being cured;
   wherein the refractive index of the low refractive index upper stratum is lower than the refractive index of the high refractive index lower stratum.

### FIGURES

FIG. 1 is a transmission electron micrograph (TEM) of a cross-section of a hard coated triacetyl cellulose film from Example 1 having a stratified anti-reflective coating disclosed herein.

FIG. 2 is a transmission electron micrograph (TEM) of a cross-section of a hard coated triacetyl cellulose film from Comparative Example A not exhibiting a stratified anti-reflective coating.

### DETAILED DESCRIPTION

The present invention discloses an article comprising a substrate having a stratified anti-reflective coating thereon. The stratified anti-reflective coating on the substrate includes:
(i) a substrate; and
(ii) a stratified anti-reflective coating on said substrate, said stratified anti-reflective coating comprising:
   (iia) a high refractive index lower stratum located on said substrate comprising a low refractive index fluoroelastomer polymeric binder and a plurality of high refractive index nanoparticles which are surface functionalized with an acrylic or vinyl functional group; and
   (iib) a low refractive index upper stratum located on top of said high refractive index lower stratum comprising said low refractive index fluoroelastomer polymeric binder;

wherein the refractive index of the low refractive index upper stratum is lower than the refractive index of the high refractive index lower stratum.

The present invention also discloses a process for forming a stratified anti-reflective coating on a substrate comprising:
(i) forming a liquid mixture comprising a solvent having dissolved therein:
(i-a) a fluoroelastomer polymer;
(i-b) optionally, a multiolefinic crosslinker;
(i-c) optionally, an oxysilane having at least one polymerizable group;
   and wherein said solvent has suspended therein:
(i-d) a plurality of nanoparticles which are surface functionalized with an acrylic functional group;
(ii) coating said liquid mixture on a substrate to form a liquid mixture coating on said substrate;
(iii) removing solvent from said liquid mixture coating to form an uncured coating on said substrate; and
(iv) curing said uncured coating thereby forming a stratified anti-reflective coating comprising:
   (iv-a) a high refractive index lower stratum located on said substrate comprising said polymeric binder being cured and said plurality nanoparticles; and
   (iv-b) a low refractive index upper stratum located on top of said high refractive index lower stratum comprising polymeric binder being cured;
   wherein the refractive index of the low refractive index upper stratum is lower than the refractive index of the high refractive index lower stratum.

The term “stratum” is used to also meant layer.

The appropriate choice of particles, binders, and thicknesses needed to achieve desirable anti-reflective properties can be determined using modeling equations, described in more detail infra.

Fluoroelastomers suitable for use in forming the low refractive composition is described here in detail. For purposes of this application, a fluoroelastomer is a carbon-based polymer that contains at least about 65 weight % fluorine, preferably at least about 70 weight % fluorine, and is a substantially amorphous copolymer characterized by having carbon-carbon bonds in the copolymer backbone. A fluoroelastomer comprises repeating units arising from two or more types of monomers and has cure sites allowing for crosslinking to form a three dimensional network. A first monomer type gives rise to straight fluoroelastomer chain segments with a tendency to crystallize. A second monomer type having a bulky group is incorporated into the fluoroelastomer chain at intervals to break up such crystallization tendency and produce a substantially amorphous elastomer. Monomers of utility for straight chain segments are those without bulky substituents and include: vinylidene fluoride (VDF), CH₂═CF₂; tetrafluoroethylene (TFE), CF₂═CF₂; chlorotrifluoroethylene (CTFE), CF₂═CFCl; and ethylene (E), CH₂═CH₂. Monomers with bulky groups useful for disrupting crystallinity include hexafluoropropylene (HFP), CF₂═CFCF₃; 1-hydropentafluoropropylene, CHF═CFCF₃; 2-hydropentafluoropropylene, CF₂═CHCF3; perfluoro(alkyl vinyl ether)s (e.g., perfluoro(methyl vinyl) ether (PMVE), CF2═CFOCF₃); and propylene (P), CH₂═CHCH₃. Fluoroelastomers are generally described by A. Moore in Fluoroelastomers Handbook: The Definitive User's Guide and Databook, William Andrew Publishing, ISBN 0-8155-1517-0 (2006).

Fluoroelastomers, according to the present invention, can have at least one cure site selected from the group consisting of bromine, iodine (halogen) and ethenyl. The cure sites can be located on, or on groups attached to, the fluoroelastomer backbone and in this instance arise from including cure site monomers in the polymerization to make the fluoroelastomer. Halogenated cure sites can also be located at fluoroelastomer chain ends and arise from the use of halogenated chain transfer agents added in the polymerization to make the fluoroelastomer. The fluoroelastomer containing cure sites is subjected to reactive conditions, also referred to as curing (e.g., thermal or photochemical curing), that results in the formation of covalent bonds (i.e., crosslinks) between the fluoroelastomer and other reactive components in the uncured composition. Cure site monomers leading to the formation of cure sites located on, or on groups attached to, the fluoroelastomer backbone generally include brominated alkenes and brominated unsaturated ethers (resulting in a bromine cure site), iodinated alkenes and iodinated unsaturated ethers (resulting in an iodine cure site), and dienes containing at least one ethenyl functional group that it is not in conjugation with other carbon-carbon unsaturation (resulting in an ethenyl cure site). Additionally, or alternatively, iodine atoms, bromine atoms or mixtures thereof can be present at the fluoroelastomer chain ends as a result of the use of chain transfer agent during polymerization to make the fluoroelastomer. Fluoroelastomers of utility generally contain from about 0.25 weight % to about 1 weight % of cure site, preferably about 0.35 weight % of cure site, based on the weight of monomers comprising the fluoroelastomer.

Fluoroelastomers containing bromine cure sites can be obtained by copolymerizing brominated cure site monomers into the fluoroelastomer during polymerization to form the fluoroelastomer. Brominated cure site monomers have carbon-carbon unsaturation with bromine attached to the double bond or elsewhere in the molecule and can contain other elements including H, F and O. Examples of brominated cure site monomers include bromotrifluoroethylene, vinyl bromide, 1-bromo-2,2-difluoroethylene, perfluoroallyl bromide, 4-bromo-1,1,2-trifluorobutene, 4-bromo-3,3,4,4-tetrafluoro-1-butene, 4-bromo-1,1,3,3,4,4,-hexafluorobutene, 4-bromo-3-chloro-1,1,3,4,4-pentafluorobutene, 6-bromo-5,5,6,6-tetrafluorohexene, 4-bromoperfluoro-1-butene, and 3,3-difluoroallyl bromide. Further examples include brominated unsaturated ethers such as 2-bromo-perfluoroethyl perfluorovinyl ether and fluorinated compounds of the class BrCF₂(perfluoroalkylene)OCF═CF₂, such as CF₂BrCF₂OCF═CF₂, and fluorovinyl ethers of the class ROCF═CFBr and ROCBr═CF₂, where R is a lower alkyl group or fluoroalkyl group, such as CH₃OCF═CFBr and CF3CH₂OCF═CFBr.

Fluoroelastomers containing iodine cure sites can be obtained by copolymerizing iodinated cure site monomers into the fluoroelastomer during polymerization to form the fluoroelastomer. Iodinated cure site monomers have carbon-carbon unsaturation with iodine attached to the double bond or elsewhere in the molecule and can contain other elements including H, Br, F and O. Example iodinated cure site monomers include iodoethylene, iodotrifluoroethylene, 4-iodo-3,3,4,4-tetrafluoro-1-butene, 3-chloro-4-iodo-3,4,4-trifluorobutene, 2-iodo-1,1,2,2-tetrafluoro-1-(vinyloxy)ethane, 2-iodo-1-(perfluorovinyloxy)-1,1,2,2-tetrafluoroethylene, 1,1,2,3,3,3-hexafluoro-2-iodo-1-(perfluorovinyloxy)propane, 2-iodoethyl vinyl ether, and 3,3,4,5,5,5-hexafluoro-4-iodopentene. Further examples include olefins of the formula CHR═CHZCH₂CHRI, wherein each R is independently H or CH₃, and Z is a C1-C18 (per)fluoroalkylene radical, linear or branched, optionally containing one or more ether oxygen atoms, or a (per)fluoropolyoxyalkylene radical. Further examples of iodinated cure site monomers of utility are unsaturated ethers of the formula I(CH₂CF₂CF₂)nOCF═CF₂ and ICH₂CF₂O[CF(CF₃)CF₂O]ₙCF═CF₂, wherein n=1-3.

Fluoroelastomers containing ethenyl cure sites can be obtained by copolymerizing ethenyl containing cure site monomers into the fluoroelastomer during polymerization to form the fluoroelastomer. Ethenyl cure site monomers have carbon-carbon unsaturation with ethenyl functionality that it is not in conjugation with other carbon-carbon unsaturation. Thus, ethenyl cure sites can arise from non-conjugated dienes having at least two points of carbon-carbon unsaturation and optionally containing other elements including H, Br, F and O. One point of carbon-carbon unsaturation is incorporated (i.e., polymerizes) into the fluoroelastomer backbone, the other is pendant to the fluoroelastomer backbone and is available for reactive curing (i.e., cross linking). Example ethenyl cure site monomers include non-conjugated dienes and trienes such as 1,4-pentadiene, 1,5-hexadiene, 1,7-octadiene, 8-methyl-4-ethylidene-1,7-octadiene and the like.

Preferred amongst the cure site monomers are bromotrifluoroethylene, 4-bromo-3,3,4,4-tetrafluoro-1-butene and 4-iodo-3,3,4,4-tetrafluoro-1-butene-1.

In addition, or alternatively, to the aforementioned cure sites, halogen cure sites can be present at fluoroelastomer chain ends as the result of the use of bromine and/or iodine (halogenated) chain transfer agents during polymerization of the fluoroelastomer. Such chain transfer agents include halogenated compounds that result in bound halogen at one or both ends of the polymer chains. Example chain transfer agents of utility include methylene iodide, 1,4-diiodoperfluoro-n-butane, 1,6-diiodo-3,3,4,4-tetrafluorohexane, 1,3-diiodoperfluoropropane, 1,6-diiodoperfluoro-n-hexane, 1,3-diiodo-2-chloroperfluoropropane, 1,2-di(iododifluoromethyl)perfluorocyclobutane, monoiodoperfluoroethane, monoiodoperfluorobutane, 2-iodo-1-hydroperfluoroethane, 1-bromo-2-iodoperfluoroethane, 1-bromo-3-iodoperfluoropropane, and 1-iodo-2-bromo-1,1-difluoroethane. Preferred are chain transfer agents containing both iodine and bromine.

Fluoroelastomers containing cure sites can be prepared by polymerization of the appropriate monomer mixtures with the aid of a free radical initiator either in bulk, in solution in an inert solvent, in aqueous emulsion or in aqueous suspension. The polymerizations may be carried out in continuous, batch, or in semi-batch processes. General polymerization processes of utility are discussed in the aforementioned Moore Fluoroelastomers Handbook. General fluoroelastomer preparative processes are disclosed in U.S. Pat. Nos. 4,281,092; 3,682,872; 4,035,565; 5,824,755; 5,789,509; 3,051,677; and 2,968,649

Example fluoroelastomers containing cure sites include: copolymers of cure site monomer, vinylidene fluoride, hexafluoropropylene and, optionally, tetrafluoroethylene; copolymers of cure site monomer, vinylidene fluoride, hexafluoropropylene, tetrafluoroethylene and chlorotrifluoroethylene; copolymers of cure site monomer, vinylidene fluoride, perfluoro(alkyl vinyl ether) and, optionally, tetrafluoroethylene; copolymers of cure site monomer, tetrafluoroethylene, propylene and, optionally, vinylidene fluoride; and copolymers of cure site monomer, tetrafluoroethylene and perfluoro(alkyl vinyl ether), preferably perfluoro(methyl vinyl ether). Fluoroelastomers containing vinylidene fluoride are preferred.

Fluoroelastomers comprising ethylene, tetrafluoroethylene, perfluoro(alkyl vinyl ether) and a bromine-containing cure site monomer, such as those disclosed by Moore, in U.S. Pat. No. 4,694,045, are of utility in the compositions of the present invention. Also of utility are copolymers of hexafluoropropylene, vinylidene fluoride, tetrafluoroethylene, and halogen cure site monomer such as the VITON® GF-series fluoroelastomers, for example VITON® GF-2005, available from DuPont Performance Elastomers, DE, USA.

Another optional component of the uncured composition is at least one multiolefinic crosslinker. By “multiolefinic” it is meant that it contains at least two carbon-carbon double bonds that are not in conjugation with one another. Multiolefinic crosslinker is present in the uncured composition in an amount of from about 1 to about 25 parts by weight per 100 parts by weight cross-linkable polymer (phr, parts per hundred), preferably from about 1 to about 10 phr. Multiolefinic crosslinkers of utility include those containing acrylic (e.g., acryloyloxy, methacryloyloxy) and allylic functional groups.

A preferred multiolefinic crosslinker is non-fluorinated multiolefinic crosslinker. By “non-fluorinated” is meant that it contains no covalently bonded fluorine atoms.

Acrylic multiolefinic crosslinkers include those represented by the formula R(OC(═O)CR′═CH₂)n, wherein: R is linear or branched alkylene, linear or branched oxyalkylene, aromatic, aromatic ether, or heterocyclic; R′ is H or CH₃; and n is an integer from 2 to 8. Representative polyols from which acrylic multiolefinic crosslinkers can be prepared include: ethylene glycol, propylene glycol, triethylene glycol, trimethylolpropane, tris-(2-hydroxyethyl) isocyanurate, pentaerythritol, ditrimethylolpropane and dipentaerythritol. Representative acrylic multiolefinic crosslinkers include 1,3-butylene glycol di(meth)acrylate, 1,6-hexanediol di(meth)acrylate, neopentyl glycol di(meth)acrylate, polyethylene glycol di(meth)acrylate, polypropylene glycol di(meth)acrylate, ethoxylated bisphenol A di(meth)acrylate, propoxylated bisphenol A di(meth)acrylate, alkoxylated cyclohexane dimethanol di(meth)acrylate, cyclohexane dimethanol di(meth)acrylate, trimethylolpropane tri(meth)acrylate, ethoxylated trimethylolpropane tri(meth)acrylate, propoxylated trimethylolpropane tri(meth)acrylate, bistrimethylolpropane tetra(meth)acrylate, tris(2-hydroxy ethyl)isocyanurate tri(meth)acrylate, pentaerythritol tri(meth)acrylate, pentaerythritol tetra(meth)acrylate, ethoxylated glycerol tri(meth)acrylate, propoxylated glycerol tri(meth)acrylate, pentaerythritol tetra(meth)acrylate, ethoxylated pentaerythritol tetra(meth)acrylate, propoxylated pentaerythritol tetra(meth)acrylate, dipentaerythritol penta(meth)acrylate, dipentaerythritol hexa(meth)acrylate, and combinations thereof. Herein, the designation “(meth)acrylate” is meant to encompass both acrylate and methacrylate.

Allylic multiolefinic crosslinkers include those represented by the formula R(CH₂CR′═CH₂)n, wherein R is linear or branched alkylene, linear or branched oxyalkylene, aromatic, aromatic ether, aromatic ester or heterocyclic; R′ is H or CH₃; and n is an integer from 2 to 6. Representative allylic multiolefinic crosslinkers include 1,3,5-triallyl isocyanurate, 1,3,5-triallyl cyanurate, and triallyl benzene-1,3,5-tricarboxylate.

Another optional component of the uncured composition is at least one oxysilane. Oxysilanes of utility in forming the low refractive index composition according to the present invention are compounds comprising: i) an acryloyloxy or methacryloyloxy functional group, ii) an oxysilane functional group, and iii) a divalent organic radical connecting the acryloyloxy or methacryloyloxy functional group and the oxysilane functional group. Oxysilane includes those represented by the formula X—Y—SiR¹R²R³. X represents an acryloyloxy (CH₂═CHC(═O)O—) or methacryloyloxy (CH₂═C(CH₃)C(═O)O—) functional group. Y represents a divalent organic radical covalently bonded to the acryloyloxy or methacryloyloxy functional group and the oxysilane functional group. Examples of Y radicals include substituted and unsubstituted alkylene groups having 2 to 10 carbon atoms, and substituted or unsubstituted arylene groups having 6 to 20 carbon atoms. The alkylene and arylene groups optionally additionally have ether, ester, and amide linkages therein. Substituents include halogen, mercapto, carboxyl, alkyl and aryl. SiR¹ R²R³ represents an oxysilane functional group containing three substituents (R¹⁻³), one to all of which are capable of being displaced by (e.g., nucleophilic) substitution. For example, at least one of the R¹⁻³ substituents are groups such as alkoxy, aryloxy or halogen and the substituting group comprises a group such as hydroxyl present on an oxysilane hydrolysis or condensation product, or equivalent reactive functional group present on the substrate film surface. Representative SiR¹R²R³oxysilane substitution includes where R¹ is C₁-C₂₀ alkoxy, C₆-C₂₀ aryloxy, or halogen, and R² and R³ are independently selected from C₁-C₂₀ alkoxy, C₆-C₂₀ aryloxy, C₁-C₂₀ alkyl, C₆-C₂₀ aryl, C₇-C₃₀ aralkyl, C₇-C₃₀ alkaryl, halogen, and hydrogen. R¹ is preferably C₁-C₄ alkoxy, C₆-C₁₀ aryloxy or halogen . Example oxysilanes include: acryloxypropyltrimethoxysilane (APTMS, H₂C═CHCO₂(CH₂)₃Si(OCH₃)₃), acryloxypropyltriethoxysilane, acryloxypropylmethyldimethoxysilane, methacryloxypropyltrimethoxysilane, methacryloxypropyltriethoxysilane, and methacryloxypropylmethyldimethoxysilane. Preferred amongst the oxysilanes is APTMS.

The oxysilane can be pre-hydrolyzed before use. Pre-hydrolysis means that at least one of the R¹⁻³ substituents in the oxysilane has been replaced by hydroxyl. For example, X—Y—SiR₂OH, X—Y—SiR(OH)₂, and X—Y—Si(OH)₃. By oxysilane condensation product is meant a product formed by condensation reaction of one or more oxysilane and/or oxysilane hydrolysis products. For example, condensation products include: X—Y—Si(R¹)(R²)OSi(R¹)(OH)—Y—X; X—Y—Si(R¹)(OH)OSi(R¹)(OH)—Y—X; X—Y—Si(OH)₂OSi(R¹)(OH)—Y—X; X—Y—Si(R¹)(OH)OSi(R¹)(OSi(R¹)(OH)—Y—X)—Y—X; and X—Y—Si(R¹)(R²)OSi(R¹)(OSi(R¹)(OH)—Y—X)—Y—X.

Oxysilane hydrosylate and/or condensate is formed by contacting the oxysilane with from about 3 to about 9 moles of water per mole of hydrolyzable functional group bonded to the silicon of the oxysilane. The hydrolysis of the oxysilane is considered complete after 24 hours at 25° C. because less than 1wt % APTMS residual occurs after hydrolysis. In a preferred embodiment, oxysilane hydrosylate and/or condensate is formed by contacting the oxysilane with from about 4 to about 9 moles of water per mole of hydrolyzable functional group bonded to the silicon of the oxysilane. In a more preferred embodiment, oxysilane hydrosylate and/or condensate is formed by contacting the oxysilane with from about 5 to about 7 moles of water per mole of hydrolyzable functional group bonded to the silicon of the oxysilane. The carbon-carbon double bond containing functional group attached to the oxysilane functional group are unaffected by conditions used to form the oxysilane hydrosylate and/or condensate.

The oxysilane hydrosylate and/or condensate is formed by contacting the oxysilane with water in the presence of a lower alkyl alcohol solvent. Representative lower alkyl alcohol solvents include aliphatic and alicyclic C₁-C₅ alcohols such as methanol, ethanol, n-propanol, isopropanol and cyclopentanol with ethanol being preferred.

The oxysilane hydrosylate and/or condensate is formed by contacting the oxysilane with water in the presence of an organic acid that catalyzes hydrolysis of one, two or three of the oxysilane substituents R¹⁻³, and further may catalyze condensation of the resultant oxysilane hydrosylates. The organic acids catalyze hydrolysis of oxysilane substituents such as alkoxy and aryloxy, and result in the formation of hydroxyl (silanol) groups in their place. Organic acids comprise the elements carbon, oxygen and hydrogen, optionally nitrogen and sulfur, and contain at least one labile (acidic) proton. Example organic acids include carboxylic acids such as acetic acid, maleic acid, oxalic acid, and formic acid, as well as sulfonic acids such as methanesulfonic acid and toluene sulfonic acid. In one embodiment, the organic acids have a pKa of at least about 4.7. A preferred organic acid is acetic acid.

In one embodiment, a concentration of from about 0.1 weight % to about 1 weight % organic acid in lower alkyl alcohol solvent is of utility for forming the oxysilane hydrosylate and/or condensate from the oxysilane. In one embodiment, a concentration of about 0.4 weight % organic acid in lower alkyl alcohol solvent is of utility for forming the oxysilane hydrosylate and/or condensate from the oxysilane.

The conditions taught herein for the reaction of oxysilane and water in the presence of organic acid and lower alkyl alcohol result in less than about 1 mol % of unhydrolyzed oxysilane (X—Y—SiR¹R²R³) remaining in the formed oxysilane hydrosylate and/or condensate.

In the embodiment where UV curing is used to cure the uncured composition, a mixture of acrylic multiolefinic crosslinker and allylic multiolefinic crosslinker is of utility. For example, a weight ratio mixture of from about 2:1 to about 1:2, preferably about 1:1, of acrylic to allylic multiolefinic crosslinkers. The acrylic crosslinker is typically alkoxylated polyol polyacrylate, especially ethoxylated (3 mol) trimethylolpropane triacrylate, and the allylic crosslinker is typically 1,3,5-triallyl isocyanurate.

In one embodiment of uncured composition: the cross-linkable polymer is fluoroelastomer having at least one cure site selected from the group consisting of bromine and iodine, especially iodine; the multiolefinic crosslinker is an allylic multiolefinic crosslinker, especially 1,3,5-triallyl isocyanurate; the uncured composition contains photoinitiator; the uncured composition contains polar aprotic organic solvent; and UV curing is used to cure the uncured composition.

Uncured compositions comprising a mixture of at least one reactive component that can be cured (e.g., cross-linkable polymer and multiolefinic cross linker) are cured to form compositions. The uncured compositions are preferably cured via a free radical mechanism. Free radicals may be generated by known methods such as by the thermal decomposition of organic peroxides, azo compounds, persulfates, redox initiators, and combinations thereof, optionally included in the uncured composition, or by radiation such as ultraviolet (UV) radiation, gamma radiation, or electron beam radiation, optionally in the presence of a photoinitiator. The uncured compositions are preferably cured via irradiation with UV radiation.

When UV radiation initiation is used to cure the uncured composition, the uncured composition can include photoinitiator, generally between 1 and 10 phr, preferably between 5 and 10 phr of photo-initiator. Photoinitiators may be used singly or in combinations of two or more. Free-radical photoinitiators of utility include, those generally useful to UV cure acrylate polymers. Example photoinitiators of utility include benzophenone and its derivatives; benzoin, alpha-methylbenzoin, alpha-phenylbenzoin, alpha-allylbenzoin, alpha-benzylbenzoin; benzoin ethers such as benzyl dimethyl ketal (commercially available as Irgacure® 651 (Irgacure® products available from Ciba Specialty Chemicals Corporation, Tarrytown, N.Y., USA)), benzoin methyl ether, benzoin ethyl ether, benzoin n-butyl ether; acetophenone and its derivatives such as 2-hydroxy-2-methyl-1-phenyl-1-propanone (commercially available as Darocur® 1173 (Darocur® products available from Ciba Specialty Chemicals Corporation, Tarrytown, N.Y., USA)) and 1-hydroxycyclohexyl phenyl ketone (commercially available as Irgacure® 184); 2-methyl-1-[4-methylthio)phenyl]-2-(4-morpholinyl)-1-propanone (commercially available as Irgacure® 907); alkyl benzoyl formates such as methylbenzoylformate (commercially available as Darocur® MBF); 2-benzyl-2-(dimethylamino)-1-[4-(4-morpholinyl)phenyl]-1-butanone (commercially available as Irgacure® 369); aromatic ketones such as benzophenone and its derivatives and anthraquinone and its derivatives; onium salts such as diazonium salts, iodonium salts, sulfonium salts; titanium complexes such as, for example, that which is commercially available as “CGI 784 DC”, also from Ciba Specialty Chemicals Corporation; halomethylnitrobenzenes; and mono- and bis-acylphosphines such as those available from Ciba Specialty Chemicals Corporation under the trade designations Irgacure® 1700, Irgacure® 1800, Irgacure® 1850, Irgacure® 819, Irgacure® 2005, Irgacure® 2010, Irgacure® 2020 and Darocur® 4265. Further, sensitizers such as 2- and 4-isopropyl thioxanthone, commercially available from Ciba Specialty Chemicals Corporation as Darocur® ITX, may be used in conjunction with the aforementioned photoinitiators.

Photoinitiators are typically activated by incident light having a wavelength between about 254 nm and about 450 nm. In a preferred embodiment, the uncured composition is cured by light from a high pressure mercury lamp having strong emissions around wavelengths 260 nm, 320 nm, 370 nm and 430 nm. In this embodiment, it is preferred to use a combination of at least one photoinitiator with relatively strong absorption at shorter wavelengths (i.e., 245-350 nm), and at least one photoinitiator with relatively strong absorption at longer wavelengths (i.e., 350-450 nm) to cure the present uncured compositions. Such a mixture of initiators results in the most efficient usage of energy emanating from the UV light source. Example photoinitiators with relatively strong absorption at shorter wavelengths include benzyl dimethyl ketal (Irgacure® 651) and methylbenzoyl formate (Darocur® MBF). Example photoinitiators with relatively strong absorption at longer wavelengths include 2- and 4-isopropyl thioxanthone (Darocur® ITX). An example of such mixture of photoinitiators is 10 parts by weight of a 2:1 weight ratio mixture of Irgacure® 651 and Darocur® MBF, to 1 part by weight of Darocur® ITX.

Thermal initiators may also be used together with photoinitiator when UV curing. Useful thermal initiators include, for example, azo, peroxide, persulfate and redox initiators.

UV curing of present uncured compositions can be carried out in the substantial absence of oxygen, which can negatively influence the performance of certain UV photoinitiators. To exclude oxygen, UV curing can be carried out under an atmosphere of inert gas such as nitrogen.

UV curing of present uncured compositions can be carried out at ambient temperature, but also can be carried out at an elevated temperature.

When thermal decomposition of organic peroxide is used to generate free radicals for curing the uncured composition, the uncured composition generally includes between 1 and 10 phr, preferably between 5 and 10 phr of organic peroxide. Useful free-radical thermal initiators include, for example, azo, peroxide, persulfate, and redox initiators, and combinations thereof. Organic peroxides are preferred, and example organic peroxides include: 1,1-bis(t-butylperoxy)-3,5,5-trimethylcyclohexane; 1,1-bis(t-butylperoxy)cyclohexane; 2,2-bis(t-butylperoxy)octane; n-butyl-4,4-bis(t-butylperoxy)valerate; 2,2-bis(t-butylperoxy)butane; 2,5-dimethylhexane-2,5-dihydroxyperoxide; di-t-butyl peroxide; t-butylcumyl peroxide; dicumyl peroxide; alpha, alpha′-bis(t-butylperoxy-m-isopropyl)benzene; 2,5-dimethyl-2,5-di(t-butylperoxy)hexane; 2,5-dimethyl-2,5-di(t-butylperoxy)hexene-3; benzoyl peroxide; t-butylperoxybenzene; 2,5-dimethyl-2,5-di(benzoylperoxy)hexane; t-butylperoxymaleic acid; and t-butylperoxyisopropylcarbonate. Preferred is benzoyl peroxide. Organic peroxides may be used singly or in combinations of two or more.

One or more solvents can be included in the uncured composition to reduce the viscosity of the uncured composition in order to facilitate coating. The appropriate viscosity level of uncured composition containing solvent depends upon various factors such as the desired thickness of the anti-reflective coating, application technique, and the substrate onto which the uncured composition is to be applied, and can be determined by one of ordinary skill in this field without undue experimentation. Generally, the amount of solvent in the uncured composition is about 10 weight % to about 60 weight %, preferably from about 20 weight % to about 40 weight %.

The solvent is selected such that it does not adversely affect the curing properties of the uncured composition or attack the optical display substrate. Additionally, solvent is chosen such that the addition of the solvent to the uncured composition does not result in flocculation of the nanoparticles. Furthermore, the solvent should be selected such that it has an appropriate drying rate. That is, the solvent should not dry too slowly, which can undesirably delay the process of making an anti-reflective coating from the uncured composition. It should also not dry too quickly, which can cause defects such as pinholes or craters in the resultant anti-reflective coating. Solvents of utility include polar aprotic organic solvents, and representative examples include aliphatic and alicyclic: ketones such as methyl ethyl ketone and methyl isobutyl ketone; esters such as propyl acetate; ethers such as di-n-butyl ether; and combinations thereof. Preferred solvents include propyl acetate and methyl isobutyl ketone. Lower alkyl hydrocarbyl alcohols (e.g., methanol, ethanol, isopropanol, etc.) can be present in the solvent, but should comprise about 8% or less by weight of the solvent when the cross-linkable polymer is fluoroelastomer having at least one cure site selected from the group consisting of bromine, iodine and ethenyl.

The solid nanoparticles can be any shape, including spherical and oblong, and are relatively uniform in size and remain substantially non-aggregated, as long as they can be used to satisfy the refractive index requirements of the bounding equations in the present invention. They can be hollow, porous, or solid. The diameter of the particles are dependent on the relative refractive index of the particle and binder used, but in general should be small enough to avoid objectionable light scattering and be less than the thickness of the stratum. Typically the median diameter is less than about 100 nm, preferably less than 70 nm. The concentration of the nanoparticles are dependent on the particle's refractive index of the particle and the binder, and is dependent on the solutions of the equations described infra.

The nanoparticles are typically inorganic oxides, such as but not limited to titanium oxide, aluminum oxide, antimony oxide, zirconium oxide, indium tin oxide, antimony tin oxide, mixed titanium/tin/zirconium oxides, and binary, ternary, quaternary and higher order composite oxides of one or more cations selected from titanium, aluminum, antimony, zirconium, indium, tin, niobium, tantalum, and zinc. More than one type of nanoparticle may be used in combination. In other cases, nanoparticle composites (e.g. single or multiple core/shell structures) can be used, in which one oxide encapsulates another oxide in one particle. The refractive index of the nanoparticles is not critical as long as the refractive index satisfies the equations as described herein, but typically the composite refractive index of the combination of particles is 1.6.

In one embodiment, the nanoparticles are conductive or semiconductive, which would produce a coating with antistatic properties. Typical metal particles that can be used include indium tin oxide, antimony tin oxide, Sb₂O₃, Sb₂O₅, In₂O ₃, SnO₂, antimony zinc oxide, zinc oxide, aluminum-zinc oxide, tungsten oxide, molybdenum oxide, vanadium oxide and iron oxide.

Substrates suitable for the stratified anti-reflective coating described herein find use as display surfaces, optical lenses, windows, optical polarizers, optical filters, glossy prints and photographs, clear polymer films, and the like. Substrates may be either transparent, anti-smudge or anti-glare and include acetylated cellulose (e.g., triacetyl cellulose (TAC)), polyester (e.g., polyethylene terephthalate (PET)), polycarbonate, polymethylmethacrylate (PMMA), polyacrylate, polyvinyl alcohol, polystyrene, glass, vinyl, nylon, and the like. Preferred substrates are TAC, PET, PMMA, and glass. The substrates optionally have a hardcoat applied between the substrate and the anti-reflective coating, such as but not limited to an acrylate hardcoat. They can also have other layers such as an antistat layer applied on top of the hardcoat.

The nanoparticles are surface functionalized with an acrylic or a vinyl functional group which can be polymerizable. By “acrylic functional group” it is meant CH₂═CH₂—C(O)O— with optional alkyl substitutions, such as methacrylic functionalities. Specifically, the acrylic functional group can be represented by the formula X—Y—Si—, where the fragment can be covalent grafted to the surface of the nanoparticles using the reaction of surface hydroxyls with oxysilanes of the type X—Y—SiR¹R²R³. X represents an acryloyloxy (CH₂═CHC(═O)O—) or methacryloyloxy (CH₂═C(CH₃)C(═O)O—) functional group. Y represents a divalent organic radical covalently bonded to the acryloyloxy or methacryloyloxy functional group and the oxysilane functional group. Examples of Y radicals include substituted and unsubstituted alkylene groups having 2 to 10 carbon atoms, and substituted or unsubstituted arylene groups having 6 to 20 carbon atoms. The alkylene and arylene groups optionally additionally have ether, ester, or amide linkages therein. Substituents include halogen, mercapto, carboxyl, alkyl and aryl. SiR¹R²R³ represents an oxysilane functional group containing three substituents (R¹⁻³), one or all of which are capable of being displaced by (e.g., nucleophilic) substitution. For example, at least one of the R¹, R², and R³ substituents are groups such as alkoxy, aryloxy or halogen and the substituting group comprises a group such as hydroxyl present on an oxysilane hydrolysis or condensation product, or equivalent reactive functional group present on the substrate film surface. Representative SiR¹R²R³ oxysilane substitution includes where R¹ is C₁-C₂₀ alkoxy, C₆-C₂₀ aryloxy, or halogen, and R² and R³ are independently selected from C₁-C₂₀ alkoxy, C₆-C₂₀ aryloxy, C₁-C₂₀ alkyl, C₆-C₂₀ aryl, C₇-C₃₀ aralkyl, C₇-C₃₀ alkaryl, halogen, and hydrogen. R¹ is preferably C₁-C₄ alkoxy, C₆-C₁₀ aryloxy or halogen. Example oxysilanes include: acryloxypropyltrimethoxysilane (APTMS, H₂C═CHCO₂(CH₂)₃Si(OCH₃)₃), acryloxypropyltriethoxysilane, acryloxypropylmethyldimethoxysilane, methacryloxypropyltrimethoxysilane, methacryloxypropyltriethoxysilane, and methacryloxypropylmethyldimethoxysilane.

A “vinyl functional group” for purposes herein means CH₂═CH₂— with optional alkyl substitutions. Specifically, the vinyl functional group can be represented by the formula X—Y—Si—, where the fragment can be covalent grafted to the surface of the nanoparticles using the reaction of surface hydroxyls oxysilanes of the type X—Y—SiR¹R²R³. X represents a vinyl CH₂═CH₂— functional group. Y represents a divalent organic radical covalently bonded to the vinyl functional group and the oxysilane functional group. Examples of Y radicals include substituted and unsubstituted alkylene groups having 2 to 10 carbon atoms, and substituted or unsubstituted arylene groups having 6 to 20 carbon atoms. The alkylene and arylene groups optionally additionally have ether, ester, or amide linkages therein. Substituents include halogen, mercapto, carboxyl, alkyl and aryl. SiR¹R²R³ represents an oxysilane functional group containing three substituents (R¹⁻³), one or all of which are capable of being displaced by (e.g., nucleophilic) substitution. For example, at least one of the R¹, R², and R³ substituents are groups such as alkoxy, aryloxy or halogen and the substituting group comprises a group such as hydroxyl present on an oxysilane hydrolysis or condensation product, or equivalent reactive functional group present on the substrate film surface. Example oxysilanes containing vinyl groups, e.g., are vinyltrimethoxysilane, vinyltriisopropoxysilane H₂C═CHSi(OR)₃, (H₂C═CH—Si(CH₃)₂NHSi(CH₃)₂CH═CH₂. Silazanes such as divinyltetramethyldisilazane can be used.

The surface functionalization can be done either subsequent to mixing with the polymeric binder or in separate reactions of the nanoparticles prior to mixing.

Suitable surface functionalized particles can be obtained commercially, or synthesized in a variety of ways. A typical process involves the mixture of an inorganic dispersion with surface functionalization agents that react with surface groups on the nanoparticles, such as reactive —OH groups.

Suitable compositions that contain acrylic functional groups include those listed herein that are also used as acrylic multiolefinic crosslinkers. Other suitable compositions include those where the acrylic functionality is an oxysilane comprising: i) an acryloyloxy or methacryloyloxy functional group, ii) an oxysilane functional group, and iii) a divalent organic radical connecting the acryloyloxy or methacryloyloxy functional group and the oxysilane functional group. Oxysilane includes those represented by the formula X—Y—SiR¹R²R³. X represents an acryloyloxy (CH₂═CHC(═O)O—) or methacryloyloxy (CH₂═C(CH₃)C(═O)O—) functional group. Y represents a divalent organic radical covalently bonded to the acryloyloxy or methacryloyloxy functional group and the oxysilane functional group. Examples of Y radicals include substituted and unsubstituted alkylene groups having 2 to 10 carbon atoms, and substituted or unsubstituted arylene groups having 6 to 20 carbon atoms. The alkylene and arylene groups optionally additionally have ether, ester, and amide linkages therein. Substituents include halogen, mercapto, carboxyl, alkyl and aryl. SiR¹R²R³ represents an oxysilane functional group containing three substituents (R¹⁻³), one to all of which are capable of being displaced by (e.g., nucleophilic) substitution. For example, at least one of the R¹⁻³ substituents are groups such as alkoxy, aryloxy or halogen and the substituting group comprises a group such as hydroxyl present on an oxysilane hydrolysis or condensation product, or equivalent reactive functional group present on the substrate film surface. Representative SiR¹R²R³ oxysilane substitution includes where R¹ is C₁-C₂₀ alkoxy, C₆-C₂₀ aryloxy, or halogen, and R² and R³ are independently selected from C₁-C₂₀ alkoxy, C₆-C₂₀ aryloxy, C₁-C₂₀ alkyl, C₆-C₂₀ aryl, C₇-C₃₀ aralkyl, C₇-C₃₀ alkaryl, halogen, and hydrogen. R¹ is preferably C₁-C₄ alkoxy, C₆-C₁₀ aryloxy or halogen. Example oxysilanes include: acryloxypropyltrimethoxysilane (APTMS, H₂C═CHCO₂(CH₂)₃Si(OCH₃)₃), acryloxypropyltriethoxysilane, acryloxypropylmethyldimethoxysilane, methacryloxypropyltrimethoxysilane, methacryloxypropyltriethoxysilane, and methacryloxypropylmethyldimethoxysilane. Preferred amongst the oxysilanes is APTMS.

The specular reflectance, also known as Rvis, were calculated using the TFCalc thin film design software, available from Software Spectra, Portland, Oreg. This software performs calculations of the optical interference from multiple thin film layers. Materials are defined by the complex dispersion relations of their index of refraction. This allows for absorption from the bulk as well as reflection from the layer surfaces. The interference calculations required that both the intensity and phase of the optical waves be treated for all possible paths and combined for calculations of the transmitted and the reflected beams. Normal angle of incidence were also accounted for in these calculations.

Three types of two stratum anti-reflective designs were used. These are known in the art as the “quarter quarter”, the “w”, and the “v” designs. These are characterized by the optical thickness of each of the two stratums in each design. In all three cases one needs a high refractive index material, also called the “high index lower stratum” adjacent to the substrate and on top of that a low refractive index material, also known as the “low index upper stratum”. It was assumed that the substrate consisted of an semi-infinitely thick TAC (tri acetal cellulose) layer (typically greater than 70 microns) with at least a 3 micron cross linked acrylic hard coat. In practice the hard coat is usually between 6 and 10 microns. The results reported are independent of the thickness of the hardcoat layer as long as it is at least several 3 microns thick. The calculations depend on the index of refraction of the hard coat layer. A typical refractive index used for this layer is 1.53 at 550 nm. Some commercial hardcoats have an index of refraction that is a function of the depth of the hard coat layer. In this case the index at the surface can be used for modeling purposes or the gradient can be used by creating a series of thinner layers to simulate the gradient. The calculations used were relatively independent of which approach is taken.

The ideal optical thickness for the three designs considered are given in Table 1 below in units of quarter waves. These assume that 550 nm is the reference wavelength, so a quarter wave is (550/4) nm. Between the extremes of the bounding equations, in general, the optical thicknesses of the strata can vary by 25%; these films will still exhibit low reflectivities. The optical thickness is defined as n*d for a non absorbing stratum, where n is the index of refraction and d is the physical thickness.

TABLE 1

| | Lower Stratum | Upper Stratum |
|---|---|---|
| Design | Optical Thickness | Optical Thickness |
| quarter quarter | 1 | 1 |
| w | 2 | 1 |
| v | 1.72 | 0.733 |

The potentially useful regions of index of refraction were explored for these three designs by varying both the index of the upper and lower stratums of the AR coatings. A preference was set in the TFCalc program to hold the optical thickness of the stratums constant when the index was varied. By doing this the physical thickness was automatically adjusted to compensate for the change in index to hold the optical thickness of each stratum constant. For each design the index was searched for refraction space for both strata systematically while calculating the luminosity of the reflection in the xyY color space. Cap Y is the luminosity value in the TFCalc program. As used herein, % Rvis is 100 times cap Y.

While it is most useful to determine the parameters of the optimum anti-reflective stratum where the Rvis is minimized, it is also necessary to define the potentially useful space. An Rvis of less than 1.3% was selected. Therefore, a procedure was followed that for each lower stratum refractive index the upper stratum index was varied away from the optimum value both upwards and downwards until Rvis increased from the optimum reflectivity to a value of 1.3%. The upper and lower bounds of the refractive index of the low index upper stratum was then recorded for each high index lower stratum refractive index. The upper and lower bounds of the refractive index for the low index upper stratum were plotted as a function of the high index lower stratum refractive index. The curves generated in these plots were fitted using least squares fitting techniques to generate empirical equations describing the range of useful values of index of refraction for each stratum of these three designs.

The simplified equations assume an Rvis of 1.3% and are based on a substrate which includes an acrylic hardcoat layer (with a thickness>2 microns) which is based on a triacetylcellulose. Other substrates (e.g. glass, hard coated PET) will be described with different equations which designate the limits of refractive indices for each of the designs.

From these equations, the real thickness can be calculated for each one of the designs that will have an Rvis of 1.3%. In the equations below, HighIndex is the index of refraction for the high index lower stratum and LowIndex the index of refraction for the low index upper stratum. Note, that in all cases, the design space of this invention covers configurations where the high refractive lower stratum has a refractive index of 1.41 or greater.

### Quarter Quarter Design

Low index upper stratum: refractive index varies from about 1.25 to about 1.40
LowIndex=1.25 to 1.40

The corresponding boundary conditions for the refractive index of the high index lower stratum for each value of the refractive index of the lower index upper stratum are shown by these equations. The high index lower bound is limited to a value of 1.41 or greater, and the configuration requires that the refractive index of the low index upper stratum is lower than the refractive index of the high index lower stratum.

HighIndex lower bound=[1.196849*LowIndex]−0.12526

HighIndex upper bound=[1.177721*LowIndex]+0.244887

### W Design

Low index upper stratum varies in refractive index from about 1.25 to about 1.46
LowIndex=1.25 to 1.46

The corresponding boundary conditions for the refractive index of the high index lower stratum for each value of the refractive index of the low index upper stratum is shown by these equations.

The high index lower bound is limited to a value of 1.41 or greater, and the configuration requires that the refractive index of the low index upper stratum is lower than the refractive index of the high index lower stratum.

HighIndex lower bound=[LowIndex²*47.39975]−[121.43156*LowIndex]+78.88532

HighIndex upper bound=[LowIndex²*(−61.309701)]+[LowIndex*160.269626]−101.960123

### V Design

The low index upper stratum varies from about 1.25 to about 1.60
LowIndex=1.25 to 1.60
HighIndex=1.41 or greater

The corresponding boundary conditions for the refractive index of the high index lower stratum for each value of the refractive index of the low index upper stratum is shown by these equations. The high index lower bound is limited to a value of 1.41 or greater, and the configuration requires that the refractive index of the low index upper stratum is lower than the refractive index of the high index lower stratum.

HighIndex lower bound=[LowIndex*1.778499]−0.820833

HighIndex upper bound=[LowIndex*1.55196]−0.03609

Between the extremes of the bounding questions, in general, the optical thicknesses of the strata can vary by 25%; these films will still exhibit low reflectivities.

The coating can be prepared by a process that includes a step of coating the liquid mixture on a substrate in a single coating step to form a liquid mixture coating on the substrate. Coating techniques useful for applying the uncured composition onto the substrate in a single coating step are those capable of forming a thin, uniform layer of liquid on a substrate, such as microgravure coating as described in US patent publication no. 2005/18733.

Suitable solvents include those listed above. The process includes a step of removing the solvent from the liquid mixture coating on the substrate to form an uncured coating on the substrate. The solvent can be removed by known methods, for example, heat, vacuum and a flow of inert gas in proximity to the coated liquid dispersion on the substrate.

Additives can be included in the coating formulation to lower the coefficient of friction (improve slip) and/or improve the leveling behavior of the film upon drying. These additives should be soluble in the solvents of the coating formulation, and can range in concentration from 0.01 to 3 wt % of the total coating formulation weight. Additives based on silicones or polysiloxanes can be used. These can include, for instance, silicone oil, high molecular weight polydimethylsiloxanes, polyether modified silicones, and silicone glycol copolymer surfactants.

The process includes a step of coating the liquid mixture on a substrate to form a liquid mixture coating. In one embodiment, the step of coating can be carried out in a single coating step. Coating techniques useful for applying the uncured composition onto the substrate in a single coating step are those capable of forming a thin, uniform layer of liquid on a substrate, such as microgravure coating, for example, as described in US patent publication no. 2005/18733.

The process includes a step of removing the solvent from the liquid mixture coating to form an uncured coating on the substrate. The solvent can be removed by known methods, for example, heat, vacuum and a flow of inert gas in proximity to the coated liquid mixture.

The process includes a step of curing the uncured coating. As discussed previously herein, the uncured coating is preferably cured by a free radical mechanism. Free radicals may be generated by known methods such as by the thermal decomposition of an organic peroxide, optionally included in the uncured composition, or by radiation such as ultraviolet (UV) radiation, gamma radiation, or electron beam radiation. Present uncured compositions are preferably UV cured due to the relative low cost and speed of this curing technique when applied on industrial scale.

### EXAMPLES

### Abbreviations and Materials

APTMS: acryloxypropyltrimethoxysilane, available from Aldrich Chemicals, St. Louis, Mo.
Darocur® ITX: mixture of 2-isopropylthioxanthone and 4-isopropylthioxanthone, photoinitiator available from Ciba Specialty Chemicals, Tarrytown, N.Y., USA
Genocure® MBF: methylbenzoylformate, photoinitiator available from Rahn USA Co., IL, USA
Irgacure® 651: 2,2-dimethoxy-1,2-diphenylethane-1-one, photoinitiator available from Ciba Specialty Chemicals, Tarrytown, N.Y., USA
Irgacure® 907: photoinitiator available from Ciba Specialty Chemicals, Tarrytown, N.Y., USA
MEK: methylethyl ketone
MIBK: methylisobutylketone
Nissan MEK-ST: silica colloid in methyl ethyl ketone, median diameter, d50, of about 10-16 nm, 30-31 wt % silica, available from Nissan Chemical America Co., Houston, Tex., USA.
Sartomer SR533: triallyl isocyanurate crosslinker, Sartomer Company, Inc., Exton, Pa.
TAIC: Triallyl-1,3,5-triazine-2,4,6(1H,3H,5H)-trione available from Alrich Chemicals, St. Louis, Mo., USA
TMP(3EO)TA: Sartomer: SR 454 available from Sartomer Company, Warrington, Pa., USA
Viton® 9267: E. I. DuPont de Nemours, Inc., Wilmington, Del.
Viton® GF200S: E. I. DuPont de Nemours, Inc., Wilmington, Del.

### Coating Method

A substrate film is coated with an uncured composition using a Yasui-Seiki Co. Ltd., Tokyo, Japan, microgravure coating apparatus as described in U.S. Pat. No. 4,791,881. The apparatus includes a doctor blade and a Yasui-Seiki Co. gravure roll) having a roll diameter of 20 mm. Coating is carried out using a gravure roll revolution of 6.0 rpm and a transporting line speed of 0.5 m/min.

The coated conditions were adjusted to yield a material with a final coated thickness (dry film) displaying the lowest reflectance at 550 nm.

The coated substrate is cured using a UV exposure unit supplied by Fusion UV Systems/Gaithersburg, Md. consisting of a LH-I6P1 UV source (200 w/cm) coupled to a DRS Conveyer/UV Processor (15 cm wide) with controlled nitrogen inerting capability over a measured range of 10 to 1,000 ppm oxygen.

Lamp power and conveyor speed are set to give a film cure using a measured energy density of 500-600 millijoules/cm² (UV-A irradiation) at about 0.7 to 1.0 m/min transport rate. An EIT UV Power Puck® radiometer is used to measure the UV total energy in the UV-A band width.

The “H” bulb used in the LH-I6P1 has the following typical spectral output in the UV-B, UV-C and UV-V bands in addition to the UV-A mentioned above as shown in the table below.

“H” Bulb Spectral Performance at 2.5 m/min, 50% Power

| | | | | | line | Exp |
|---|---|---|---|---|---|---|
| | Range | Power | Energy | time | speed | Zone |
| Band | (nm) | (w/cm²) | (J/cm²) | (sec) | (m/min) | (cm) |
| UV-C | 250-260 | 0.107 | 0.079 | 0.7 | 2.5 | 3.1 |
| UV-B | 280-320 | 0.866 | 0.648 | 0.7 | 2.5 | 3.1 |
| UV-A | 320-390 | 0.891 | 0.667 | 0.7 | 2.5 | 3.1 |
| UV-V | 395-445 | 0.603 | 0.459 | 0.8 | 2.5 | 3.2 |

The oxygen level in the unit is controlled using a nitrogen purge to be at 350 ppm or less. The cured film is placed on a metal substrate preheated to 70° C. before placing it on the cure conveyer belt.

### Measurement of Specular Reflectance (Rvis)

A 3.7 cm×7.5 cm piece of substrate film coated with an anti-reflective coating is prepared for measurement by adhering a strip of black PVC electrical tape (Nitto Denko, PVC Plastic tape #21) to the uncoated side of the film, in a manner that excludes trapped air bubbles, to frustrate the back surface reflections. The film is then held fixed and flat at normal to the spectrometer's optical path, with the coated surface facing up. The reflected light that is within about 2 degrees of normal incidence is captured and directed to on the stage of an infra-red extended range spectrometer (Filmetrics, model F50) using adhesive tape or a flat weight. The infra-red spectrometer is calibrated between 400 nm and 1700 nm with a low reflectance standard of BK7 glass with its back surface roughened and blackened. The specular reflection is measured at normal incidence with an acceptance angle of about 2 degrees. The reflection spectrum is recorded in the range from 400 nm to 1700 nm with an interval of about 1 nm. A low noise spectrum is obtained by using a long detector integration time so that the instrument is at full range or saturated with about a 6% reflection. A further noise reduction is achieved by averaging 3 or more separate measurements of the spectrum. The reflectance reported from the recorded spectrum is the result of a color calculation of x, y, and Y where Y is reported as the specular reflectance (Rᵥᵢₛ). The color coordinate calculation is performed for a 10 degree standard observer with a type C light source.

### Quantifying Surface Abrasion

A 3.7 cm by 7.5 cm piece of substrate film coated with an anti-reflective coating of the present invention is mounted, with the coated surface up, onto the surface of a flat glass plate by fastening the edges of the film to the plate with adhesive tape. Liberon grade #0000 steel wool is cut into patches slightly larger than 1 by 1 cm. A soft (compliant) foam pad cut to 1 by 1 cm is placed over the steel wool pad and a 200-gram brass weight held in a slip fit Delrin® sleeve is placed on top of the foam pad. The sleeve is moved by a stepping motor driven translation stage model MB2509P5J-S3 CO18762. A VELMEX VXM stepping motor controller drives the stepping motor. The steel wool and weight assembly are placed on the film surface and rubbed back and forth over the film surface, for 10 cycles (20 passes) over a distance of 3 cm at a velocity of 5 cm/sec.

The present method involves imaging a film abraded by the above method and quantifying the scratched percent area on the abraded film by software manipulation of the image.

No single image analysis procedure covering all possibilities exists. One of ordinary skill in the art will understand that the image analysis performed is very specific. General guidance is given here with the understanding that unspecified parameters are within the ability of the practitioner of ordinary skill to discern without undue experimentation.

This analysis assumes there are both “on axis” and “off axis” illumination of the sample and the image is taken in reflected light at about 7 degrees from normal incidence. It is also assumed that the scratches are in a vertical orientation in the image. Appropriate image contrast can be established without undue experimentation by the practitioner or ordinary skill. Image contrast is controlled by the lighting intensity, the camera white and dark reference settings, the index of refraction of the substrate, the index of refraction and the thickness of the low refractive index composition. Also to increase the contrast of the image a piece of black electrical tape is adhered to the back of the substrate. This has the effect of frustrating the back surface reflection.

The image used for analyzing the scratched area on the film generated by the above method is obtained from a video camera connected to a frame grabber card in a computer. The image is a grey scale 640 by 480 pixel image. The optics on the camera magnifies the abraded area so that the width of the imaged region is 7.3 mm (which is most of the 1 cm wide region that is abraded.)

The Adobe PhotoShop V7 with Reindeer Graphic's Image Processing Toolkit plug-ins for PhotoShop is used to process the image as described below.

First the image is converted to a grey scale image (if it is not already). A motion blur of 25 pixels in the direction of the scratches is performed to emphasize the scratches and de-emphasize noise and extraneous damage to the film. This blur does three things to clean up the image. First, damage to the film in other directions than the abrasion direction is washed out by averaging with the background. Second, individual white dots are removed by averaging with the background. Third, any small gaps in the scratches are filled in by averaging between the in line scratches.

In preparation for an automatic contrast adjustment of the pixel intensities in the image, four pixels near the upper left corner are selected. These pixels are filled in at an intensity of 200 (out of 255). This step assures that there is some mark in the image that is other than the dark background of the un-abraded material, in the event that there are no bright scratches in the image. This has the effect of limiting the automatic contrast adjustment. The automatic contrast adjustment used is called “histogram limits: max-min” which alters the contrast of the image so that the histogram fills the 0 to 255 levels available in an 8-bit grey scale image.

A custom filter is then applied to the image that takes a derivative in the horizontal direction and then adds back the original image to the derivative image. This has the effect of emphasizing the edges of vertical scratches.

A bi-level threshold is applied at the 128 grey level. Pixels at a level of 128 or higher are set to white (255) and pixels below a brightness of 128 are set to black (0). The image is then inverted making the black pixels white and the white pixels black. This is to accommodate the global measurement feature used in the final step, which is the application of the global measurement of the black area. The result is given in terms of the percent of black pixels in the image. This is the percent of the total area that is scratched by the above method (i.e., scratched %). The entire procedure takes a few seconds per image. Many abraded samples can be evaluated quickly and repeatably by this Method independent of a human operator required in conventional methods.

### Example 1

### 22.1 volume % TiO2 in Viton

TiO₂ nanoparticles with methacrylic surface functionalization containing approximately 20.5 wt % TiO₂ in MIBK were used, as supplied by Shokubai Kasei Kogyo Kabushiki Kaisha, Japan (ELCOM grade DU-1014TIV). The titanium oxide nanoparticles were approximately 20 nm in diameter as measured by dynamic light scattering. A mixture of this material was formed by combining 2.17 g of APTMS, Aldrich Chemicals, at room temperature in an inert atmosphere drybox with 8.29 grams of the TiO₂ colloid. The composite was maintained at room temperature for about 24 hours before further use.

A mixture comprising fluoroelastomer was formed by combining 18.00 g of a 10 wt % solution of Viton® GF200S in MIBK, 0.199 g Sartomer SR533, 0.025 g Darocur® ITX, 0.178 g Irgacure® 651, 0.089 g Genocure® MBF and 14.7644 g of MIBK.

To the mixture comprising fluoroelastomer was added 10.0363 g of the TiO₂ mixture containing APTMS.

The resultant uncured composition was then filtered through a 0.47μ Teflon® PTFE membrane filter and was used for coating within two to five hours of preparation.

A 40.6 cm by 10.2 cm strip of acrylate hard-coated triacetyl cellulose (TAC) film was coated with the uncured coating solution as described above. A stratified coating resulted with an Rvis of about 0.5 was obtained (Rmin=0.3%).

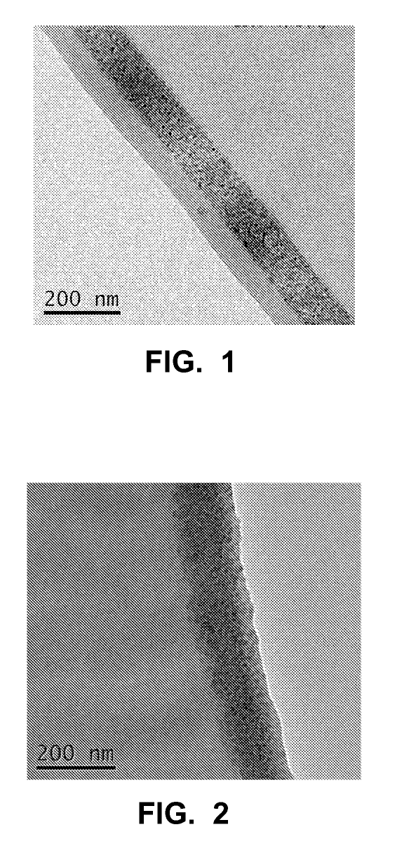

The resultant coated TAC film was ultramicrotomed at room temperature to produce cross sections 80 to 100 nm thick. The cross sections were floated onto a boat of de-ionized water adjacent to the diamond knife of the ultramicrotome and picked up from the water onto holey-carbon coated TEM grids (200 mesh Cu grids). The thin sections were imaged in a Philips CM-20 Ultratwin TEM equipped with a Link light-element energy dispersive spectroscopy (EDS) analyzer. The TEM was operated at an accelerating voltage of 200 kV and bright-field images of the cross-sectional regions of interest were obtained in the high-resolution (HR) mode and recorded on SO-163 sheet films. The image shown in FIG. 1 showing stratification was obtained at a magnification of 100 kX. The particles can be seen in the lower stratum on top of the hardcoat substrate.

### Example 2

### 17 volume % TiO2, 3 volume % SiO2 in Viton®

APTMS was prehydrolyzed by combining 0.48 g of APTMS with 7.77 g of ethanol (derived from combining 100 g of 95 volume % ethanol with 0.4 grams of glacial acetic acid). The mixture was allowed to stand for 24 hours at room temperature.

To 3.728 g of the prehydrolyzed APTMS was added 4.148 g of TiO₂ nanoparticles containing approximately 20.5 wt % TiO₂ in MIBK (Shokubai Kasei Kogyo Kabushiki Kaisha, Japan, ELCOM grade DU-1014TIV). The titanium oxide nanoparticles were approximately 20 nm in diameter as measured by dynamic light scattering. The mixture was allowed to age for 24 hours at 50 C prior to further use.

A second mixture was prepared by combining 0.795 g of the prehydrolyzed APTMS with 0.580 g of Nissan MEK-ST colloid. This mixture was allowed to age for 24 hours, at 50 C, prior to further use.

A third mixture comprising fluoroelastomer was formed by combining 12.00 g of a 10 wt % solution of Viton® GF200S in MIBK, 0.119 g Sartomer SR533, 0.071 g Irgacure® 907 and 6.73 g of MIBK.

To the third mixture comprising fluoroelastomer was added 6.564 g of the first mixture (containing TiO₂ and hydrolyzed APTMS) and 0.573 g of the second mixture (containing SiO₂ and hydrolyzed APTMS) to form the uncured composition.

The resultant uncured composition was then filtered through a 0.47μ Teflon® PTFE membrane filter and was used for coating within two to five hours of preparation.

A 40.6 cm by 10.2 cm strip of acrylate hard-coated triacetyl cellulose film was coated with the uncured coating solution as described above. An Rvis of about 0.05-0.1% was obtained (Rvis=0.3%). Stratification was observed, with both types of particles in the lower stratum on top of the hardcoat substrate.

### Example 3

### 13.7 volume % TiO₂, 9.3 volume % SiO₂ in Viton®

APTMS was prehydrolyzed by combining 1.22 g of APTMS with 19.82 g of ethanol (derived from combining 100 g of 95 volume % ethanol with 0.4 grams of glacial acetic acid). The mixture was allowed to stand for 24 hours at room temperature.

To 3.122 g of the prehydrolyzed APTMS was added 2.133 g of TiO₂ nanoparticles with methacrylic surface functionalization containing approximately 30 wt % TiO₂ in MIBK (Shokubai Kasei Kogyo Kabushiki Kaisha, Japan, ELCOM grade DU-1013TIV). The titanium oxide nanoparticles were approximately 20 nm in diameter as measured by dynamic light scattering.

A second mixture was prepared by combining 1.280 g of the prehydrolyzed APTMS with 0.935 g of Nissan MEK-ST colloid. The first and second mixtures were combined, and this combined mixture was allowed to age for 24 hours at 50 C, prior to further use.

A third mixture comprising fluoroelastomer was formed by combining 57.60 g of a 10 wt % solution of Viton® GF200S in MIBK, 0.570 g Sartomer SR533, and 0.342 Irgacure® 907.

12.190 g of this third, fluoroelastomer containing mixture was combined with 7.687 g of MIBK solvent. To this mixture was then added 6.224 g of the combined first and second mixtures (containing TiO₂ and hydrolyzed APTMS and SiO₂ and hydrolyzed APTMS) to form the uncured composition.

The resultant uncured composition was then filtered through a 0.47μ Teflon® PTFE membrane filter and was used for coating within two to five hours of preparation, forming a bilayer with the particles in the lower stratum.

### Example 4

### 13.7 volume % TiO₂, 9.3 volume % SiO₂ in Viton®

APTMS was prehydrolyzed by combining 1.22 g of APTMS with 19.82 g of ethanol (derived from combining 100 g of 95 volume % ethanol with 0.4 grams of glacial acetic acid). The mixture was allowed to stand for 24 hours at room temperature.

To 3.122 g of the prehydrolyzed APTMS was added 2.133 g of TiO₂ nanoparticles with methacrylic surface functionalization containing approximately 30 wt % TiO₂ in MIBK (Shokubai Kasei Kogyo Kabushiki Kaisha, Japan, ELCOM grade DU-1013TIV). The titanium oxide nanoparticles were approximately 20 nm in diameter as measured by dynamic light scattering.

A second mixture was prepared by combining 1.280 g of the prehydrolyzed APTMS with 0.935 g of Nissan MEK-ST colloid. The first and second mixtures were combined, and this combined mixture was allowed to age for 24 hours at 50° C., prior to further use.

A third mixture comprising fluoroelastomer was formed by combining 57.60 g of a 10 wt % solution of Viton® GF200S in MIBK, 0.570 g Sartomer SR533, and 0.342 Irgacure® 907.

12.190 g of this third, fluoroelastomer containing mixture was combined with 7.687 g of MIBK solvent. To this mixture was then added 6.224 g of the combined first and second mixtures (containing TiO₂ and hydrolyzed APTMS and SiO₂ and hydrolyzed APTMS) to form the uncured composition.

The resultant uncured composition was then filtered through a 0.47μ Teflon® PTFE membrane filter and was used for coating within two to five hours of preparation forming a bilayer with the particles in the lower stratum with an Rvis of 0.3%.

In an inert atmosphere drybox, 100 grams of solid nanosilicon oxide in isopropyl alcohol (30 wt %, IPA-ST, Nissan Chemicals) was combined with 100 grams of isopropyl alcohol. To this mixture was added 6.37 g of 1,3 divinyltetramethyldisilazane (Gelest Company, Morrisville, Pa., Part Number SID 4612.0). The material was transferred to a round-bottom flask and the liquid mixture was brought to reflux. The typical reflux temperature was between 50 and 60° C., depending on the extent of reaction. After refluxing for approximately 4 hours, the material was allowed to cool. Approximately 80-90 g of MIBK was then added to reaction mixture.

The remaining alcohols in this reaction mixture, containing MIBK, were distilled under vacuum to produce a colloid which contains predominantly MIBK (<10% alcohols) with the functionalized nanosilicon oxide; a gravimetric measurement was used to determine the final solids content in the colloid. The colloid was filtered through 0.45 micron Teflon® filters prior to use.

The same procedure as above was used to prepare a coating composition and further used for coating, forming a bilayer with the particles in the lower stratum with an Rvis of 0.34%.

The coated articles were both tested for scratch resistance and showed about 10% scratched area at 200 grams.

### Comparative Example A

The following examples illustrates that an acrylic functionalized particle forms a bilayer whereas an identical particle with allylic functionality forms a single layer.

A composite was formed by combining 0.84 g allyltrimethoxysilane at room temperature with 16.67 g of Nissan MEK-ST (solid nanosilicon oxide). The composite was maintained at room temperature for about 24 hours before further use.

A mixture comprising fluoroelastomer is formed by combining 45 g of a 10 wt % solution of Viton® GF200S (dry density 1.8 g/cc) in propyl acetate, 0.45 g benzoyl peroxide (dry density 1.33 g/cc) and 0.45 g Sartomer SR533(dry density 1.16 g/cc) in 59.48 g propyl acetate.

9.60 g of the composite is added to the mixture comprising fluoroelastomer, at room temperature, to form an uncured composition. The uncured composition is then filtered through a 0.47μ Teflon® PTFE membrane filter and used for coating within two to five hours of preparation.

A 40.6 cm by 10.2 cm strip of antistatic treated, acrylate hard-coated triacetyl cellulose film is coated with uncured composition by the same method as described above. The coated film is cut into 10.2 cm by 12.7 cm sections and cured by heating for 20 minutes at 120C under a nitrogen atmosphere. The cured coatings have a thickness of about 100 nm. A TEM image, FIG. 2, was taken as described in Example 1, and no bilayer formation was seen.

A composite was formed by combining 1.32 g of APTMS at room temperature with 16.67 g of Nissan MEK-ST (dry density 2.32 g/cc). The composite was maintained at room temperature for about 24 hours before further use. Following this period, the composite contains APTMS and hydrolysis and condensation products of APTMS.

A mixture comprising fluoroelastomer was formed by combining 45 g of a 10 wt % solution of Viton® GF200S (dry density 1.8 g/cc) in propyl acetate, 0.45 g benzoyl peroxide (dry density 1.33 g/cc) and 0.45 g Sartomer SR533 (dry density 1.16 g/cc) in 60.14 g propyl acetate. 8.94 g of the composite was added to the mixture comprising fluoroelastomer, at room temperature, to form an uncured composition. The uncured composition was then filtered through a 0.47μ Teflon® PTFE membrane filter and used for coating within two to five hours of preparation.

A 40.6 cm by 10.2 cm strip of antistatic treated, acrylate hard-coated triacetyl cellulose film was coated with uncured composition. The coated film was cut into 10.2 cm by 12.7 cm sections and cured by heating for 20 minutes at 120° C. under a nitrogen atmosphere. The cured coatings had a thickness of about 100 nm and showed a bilayer.

Rvis was measured as described above and determined to be 1.54.

It is therefore, apparent that there has been provided in accordance with the present invention, an article having a stratified anti-reflective coating on a substrate that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

1. An article comprising:
(i) a substrate; and
(ii) a stratified anti-reflective coating on said substrate, said stratified anti-reflective coating comprising:
(iia) a high refractive index lower stratum located on said substrate comprising a low refractive index fluoroelastomer polymeric binder and a plurality of nanoparticles which are surface functionalized with an acrylic or vinyl functional group; and
(iib) a low refractive index upper stratum located on top of said high refractive index lower stratum comprising said low refractive index fluoroelastomer polymeric binder;
wherein a refractive index of the low refractive index upper stratum is lower than a refractive index of the high refractive index lower stratum.

2. The article of claim 1, wherein the refractive index of the high refractive index lower stratum is 1.41 or greater.

3. The article of claim 1, wherein:
the substrate is an acrylate hard-coated triacetyl cellulose;
the low refractive index upper stratum has an optical thickness of a quarter wave at 550 nm and a refractive index value of LowIndex ranging from about 1.25 to about 1.40 at 550 nm;
the high refractive index lower stratum has an optical thickness of a quarter wave at 550 nm and a refractive index value of HighIndex, ranging from a lower bound calculated by
[1.196849*LowIndex]−0.12526
to an upper bound calculated by
[1.177721*LowIndex]+0.244887.

4. The article of claim 1, wherein:
the substrate is an acrylate hard-coated triacetyl cellulose;
the low refractive index upper stratum has an optical thickness of a quarter wave at 550 nm and a refractive index value of LowIndex ranging from about 1.25 to about 1.46;
and the high refractive index lower stratum has an optical thickness of twice a quarter wave at 550 nm and a refractive index value of HighIndex ranging from a lower bound calculated by
[LowIndex²*47.39975]−[121.43156*LowIndex]+78.88532
to an upper bound calculated by
[LowIndex^{2*}(−61.309701)]+[LowIndex*160.269626]−101.960123.

5. The article of claim 1, wherein:
the substrate is an acrylate hard-coated triacetyl cellulose;
the low refractive index upper stratum has an optical thickness of 0.733 of a quarter wave at 550 nm and a refractive index value of LowIndex ranging from about 1.25 to about 1.60;
and the high refractive index lower stratum has an optical thickness of 1.72 of a quarter wave at 550 nm and a refractive index value of HighIndex ranging from a lower bound calculated by
[LowIndex*1.778499]−0.820833
to an upper bound calculated by
[LowIndex*1.778499]−0.820833.

6. The article of claim 1, wherein said nanoparticles comprise inorganic oxides with at least one member selected from the group consisting of titanium oxide, aluminum oxide, antimony oxide, zirconium oxide, indium tin oxide, antimony tin oxide, mixed titanium/tin/zirconium oxides, and binary, ternary, quaternary and higher order composite oxides of one or more cations, said cations selected from the group consisting of titanium, aluminum, antimony, zirconium, indium, tin, zinc, niobium and tantalum, and combinations thereof.

7. The article of claim 1, wherein said stratified anti-reflective coating has anti-static properties.

8. The article of claim 1, wherein said stratified anti-reflective coating is formed on said substrate in a single coating step.

9. The article of claim 1, wherein said substrate comprises triacetyl cellulose, acetylated cellulose, polyethylene terephthalate, polycarbonate, polymethylmethacrylate, polyacrylate, polyvinyl alcohol, polystyrene, glass, vinyl, or nylon, and wherein the substrate, optionally, is treated with an acrylate hard-coat.

10. A process comprising:
(i) forming a liquid mixture comprising a solvent having dissolved therein:
(i-a) a fluoroelastomer polymer;
(i-b) optionally, a multiolefinic crosslinker;
(i-c) optionally, an oxysilane having at least one polymerizable group;
and wherein said solvent has suspended therein:
(i-d) a plurality of nanoparticles which are surface functionalized with an acrylic functional group;
(ii) coating said liquid mixture on a substrate to form a liquid mixture coating on said substrate;
(iii) removing the solvent from said liquid mixture coating to form an uncured coating on said substrate; and
(iv) curing said uncured coating thereby forming a stratified anti-reflective coating comprising:
(iv-a) a high refractive index lower stratum located on said substrate comprising a polymeric binder being cured and said plurality of nanoparticles; and
(iv-b) a low refractive index upper stratum located on top of said high refractive index lower stratum comprising polymeric binder being cured;
wherein a refractive index of the low refractive index upper stratum is lower than a refractive index of the high refractive index lower stratum.

11. The process of claim 10, wherein said refractive index of the high refractive index lower stratum is 1.41 or greater.

12. The process of claim 10 wherein:
said substrate is an acrylate hard-coated triacetyl cellulose;
the low refractive index upper stratum has an optical thickness of a quarter wave at 550 nm and a refractive index value of LowIndex, ranging from about 1.25 to about 1.40;
the high refractive index lower stratum has an optical thickness of a quarter wave at 550 nm and a refractive index value of HighIndex, with the HighIndex ranging from a lower bound calculated by
[1.196849*LowIndex]−0.12526
to an upper bound calculated by
[1.177721*LowIndex]+0.244887.

13. The process of claim 10, wherein:
said substrate is an acrylate hard-coated triacetyl cellulose;
the low refractive index upper stratum has an optical thickness of a quarter wave at 550 nm and a refractive index value of LowIndex, ranging from about 1.25 to about 1.46;
and the high refractive index lower stratum has an optical thickness of twice a quarter wave at 550 nm and a refractive index value of HighIndex, ranging from a lower bound calculated by
[LowIndex²*47.39975]−[121.43156*LowIndex]+78.88532
to an upper bound calculated by
[LowIndex²*(−61.309701)]+[LowIndex*160.269626]−101.960123.

14. The process of claim 10, wherein:
said substrate is an acrylate hard-coated triacetyl cellulose;
the low refractive index upper stratum has an optical thickness of 0.733 of a quarter wave at 550 nm and a refractive index value of LowIndex ranging from about 1.25 to about 1.60;
and the high refractive index lower stratum has an optical thickness of 1.72 of a quarter wave at 550 nm and a refractive index value of HighIndex ranging from a lower bound calculated by
[LowIndex*1.778499]−0.820833
to an upper bound calculated by
[LowIndex*1.778499]−0.820833.

15. The process of claim 10, wherein said nanoparticles comprise inorganic oxides with at least one member selected from the group consisting of titanium oxide, aluminum oxide, antimony oxide, zirconium oxide, indium tin oxide, antimony tin oxide, mixed titanium/tin/zirconium oxides, and binary, ternary, quaternary and higher order composite oxides of one or more cations, said cations selected from the group consisting of titanium, aluminum, antimony, zirconium, indium, tin, zinc, niobium and tantalum, and combinations thereof.

16. The process of claim 10, wherein said stratified anti-reflective coating has anti-static properties.

17. The process of claim 10, wherein said stratified anti-reflective coating is formed on said substrate in a single coating step.

18. The process of claim 10, wherein said substrate comprises triacetyl cellulose, acetylated cellulose, polyethylene terephthalate, polycarbonate, polymethylmethacrylate, polyacrylate, polyvinyl alcohol, polystyrene, glass, vinyl, or nylon, and wherein the substrate, optionally, is treated with an acrylate hard-coat.
